(19) United States
(12) Patent Application Publication
(10) Pub. No.: US 2024/0309989 A1
(43) Pub. Date: Sep. 19, 2024

(54) ROD ASSEMBLY AND SUPPORT DEVICE

(71) Applicant: Shenzhen Ulanzi Technology Co.Ltd, Shenzhen (CN)

(72) Inventors: Qingqing ZOU, Shenzhen (CN); Weiyan HU, Shenzhen (CN); Wei WEI, Shenzhen (CN); Guodong ZHU, Shenzhen (CN); Wei ZENG, Shenzhen (CN); Jianxiong XIA, Shenzhen (CN)

(73) Assignee: Shenzhen Ulanzi Technology Co.Ltd, Shenzhen (CN)

(21) Appl. No.: 18/219,115

(22) Filed: Jul. 7, 2023

(30) Foreign Application Priority Data
Mar. 14, 2023 (CN) 202320540699.5

(51) Int. Cl. F16M 11/32; F16M 11/14; F16M 11/28; G03B 17/56

(52) U.S. Cl. CPC F16M 11/32; F16M 11/14; F16M 11/28; G03B 17/561; F16M 2200/022; F16M 2200/027

(57) ABSTRACT

A rod assembly and a support device includes a first rod member, a second rod member, and a threaded connector, where the first rod member is provided with a mounting groove; the second rod member is provided with a mounting seat detachably connected to the mounting groove; and the threaded connector is connected to the mounting seat in a threaded manner, and rotatable relative to the mounting seat, allowing the threaded connector to be clamped to the first rod member and the mounting seat, and to push the mounting seat such that an outer surface of the mounting seat is abutted against a wall of the mounting groove. The threaded connector of the rod assembly increases a friction force and restricts the second rod member from rotating relative to the first rod member when the second rod member is disturbed by an external force.

### CROSS-REFERENCE TO RELATED APPLICATIONS

This application is based upon and claims priority to Chinese Patent Application No. 202320540699.5 filed on Mar. 14, 2023, the entire content of which is incorporated herein by reference.

### TECHNICAL FIELD

The present disclosure relates to the technical field of photographic accessories and in particular to a rod assembly and a support device.

### BACKGROUND

The rod assembly is mainly used in the field of photography. Specifically, the rod assembly can be used as a central axis of a tripod and generally includes a first rod member and a second rod member. The first rod member and the second rod member are connected together in a threaded manner. The threaded connection between the first rod member and the second rod member is insecure. When the second rod member is disturbed by an external force, such as when the second rod member is accidentally touched, the second rod member is prone to rotate relative to the first rod member, causing the second rod member to be detached from the first rod member.

For example, U.S. Pat. No. 11,480,290B2 provides a travel tripod, including a central post serving as a central axis of the travel tripod. The central post includes an upper part and a lower part connected to the upper part through a central post attachment rod. The central post attachment rod is connected to the upper part in a threaded manner. The threaded connection between the upper part and the lower part is insecure. When the lower part is disturbed by an external force, such as when the lower part is accidentally touched, the lower part is prone to drive the central post attachment rod to rotate relative to the upper part, causing the lower part to be detached from the upper part. The upper part and the lower part refer to the above-mentioned first rod member and second rod member, respectively.

### SUMMARY

The present disclosure provides a rod assembly. The present disclosure solves the problem existing in the prior art. That is, the threaded connection between the first rod member and the second rod member is insecure, so when the second rod member is disturbed by an external force, the second rod member is prone to rotate relative to the first rod member, causing the second rod member to be detached from the first rod member.

To solve the above technical problem, the present disclosure adopts the following technical solutions.

A first aspect of the present disclosure provides a rod assembly, including:
a first rod member, provided with a mounting groove;
a second rod member, provided with a mounting seat detachably connected to the mounting groove; and
a threaded connector, connected to the mounting seat in a threaded manner, and rotatable relative to the mounting seat, allowing the threaded connector to be clamped to the first rod member and the mounting seat, and to push the mounting seat such that an outer surface of the mounting seat is abutted against a wall of the mounting groove.

A second aspect of the present disclosure provides a support device, including:
a support leg assembly; and
a rod assembly, serving as a central axis of the support leg assembly, movably connected to the support leg assembly, and including a first rod member, a second rod member, and a threaded connector, where the first rod member is provided with a mounting groove; the second rod member is provided with a mounting seat detachably connected to the mounting groove; and the threaded connector is connected to the mounting seat in a threaded manner, and rotatable relative to the mounting seat, allowing the threaded connector to be clamped to the first rod member and the mounting seat, and to push the mounting seat such that an outer surface of the mounting seat is abutted against a wall of the mounting groove.

A third aspect of the present disclosure provides a support device, including:
a support leg assembly, including a fixed seat, multiple support legs, and multiple clamping members, where the multiple support legs are rotatably connected to the fixed seat, are spaced apart in a circumferential direction of the fixed seat, and are rotatable relative to the fixed seat to switch the support leg assembly between an unfolded state and a folded state; the multiple clamping members are provided between the fixed seat and the multiple support legs, respectively; in the unfolded state, the clamping members are able to be clamped to the fixed seat, so as to restrict rotation of the support legs relative to the fixed seat; and the support legs are further able to drive the clamping members to be detached from the fixed seat, allowing the support legs to rotate relative to the fixed seat, so as to switch the support leg assembly from the unfolded state to the folded state; and
a rod assembly, serving as a central axis of the support leg assembly, movably connected to the support leg assembly, and including a first rod member and a second rod member, where the first rod member is provided with a mounting groove; and the second rod member is provided with a mounting seat detachably connected to the mounting groove.

According to the above technical solutions, embodiments of the present disclosure have at least the following beneficial effects.

In the rod assembly provided by the present disclosure, the rod assembly is provided with the threaded connector. Specifically, when the rod assembly is used, the threaded connector can be clamped to the first rod member and the mounting seat to restrict the first rod member from being detached from the mounting seat. When the threaded connector is clamped to the first rod member and the mounting seat, the threaded connector can further push the mounting seat to make the outer surface of the mounting seat abutted against the wall of the mounting groove. In this way, the friction force between the mounting seat and the first rod member is increased. When the second rod member is disturbed by an external force, such as when the second rod member is accidentally touched, the second rod member cannot drive the mounting seat to overcome the resistance between the first rod member and the mounting seat exerted by the threaded connector, as well as the friction force between the mounting seat and the first rod member, so as to rotate relative to the first rod member. Therefore, the mounting seat cannot be detached from the first rod member, thereby achieving the fixed connection between the first rod member and the second rod member. In this way, the present disclosure solves the problem of weak connection between the first rod member and the second rod member in a traditional rod assembly. That is, the first rod member and the second rod member are connected in a threaded manner, and when the second rod member is disturbed by an external force, the second rod member is rotated relative to the first rod member to be detached from the first rod member.

### BRIEF DESCRIPTION OF THE DRAWINGS

To describe the technical solutions in the embodiments of the present application or in the prior art more clearly, the following briefly describes the drawings required for describing the embodiments or the prior art. Apparently, the drawings in the following description show some embodiments of the present application, and those of ordinary skill in the art may still derive other drawings from these drawings without creative efforts.

FIG. 1 is an overall structural diagram of a support device according to an embodiment of the present disclosure;

FIG. 2 is a section view of the support device shown in FIG. 1;

FIG. 3 is an exploded view of the support device shown in FIG. 1;

FIG. 4 is a section view of a support leg assembly shown in FIG. 3;

FIG. 5 is an enlarged view of A shown in FIG. 4;

FIG. 6 is a section view of a rod assembly shown in FIG. 3;

FIG. 7 is a section view of a first rod member shown in FIG. 6;

FIG. 8 is a section view of a mounting seat shown in FIG. 6;

FIG. 9 is an overall structural diagram of a threaded connector shown in FIG. 6.

FIG. 10 is an exploded view of the rod assembly shown in FIG. 3; and

FIG. 11 is an overall structural diagram of a gimbal holder shown in FIG. 3.

### REFERENCE NUMERALS

1. support device;
10. support leg assembly; 20. rod assembly; and 30. gimbal holder; and
110. support leg; 111. rotating seat; 112. branch tube; 113. locking member; 120. fixed seat; 121. second locking structure; 122. second clamping element; 130. clamping member; 131. first locking structure; 132. first clamping element; 133. slope; 140. elastic member; 150. adjustment knob; 210. first rod member; 211. mounting groove; 212. through hole; 213. operating hole; 220. second rod member; 221. mounting seat; 222. expansion space; 223. first connecting part; 224. second connecting part; 225. first clamping element; 226. second clamping element; 227. notch; 228. countersunk hole; 229. threaded hole; 230. threaded connector; 231. clamping end; 232. mounting end; 233. cap; 234. screw; 240. locking pin; 250. connector; 260. hook; 310. rotating part; and 320. mounting part.

### DETAILED DESCRIPTION OF THE EMBODIMENTS

The typical implementations embodying the features and advantages of the present disclosure are described in detail below. It should be understood that the present disclosure may have various changes in different implementations, which do not depart from the scope of the present disclosure. The description and drawings herein are essentially used for the purpose of explanation, rather than to limit the present disclosure.

In addition, the terms “first” and “second” are merely intended for a purpose of description, and shall not be understood as an indication or implication of relative importance or implicit indication of a quantity of indicated technical features. Therefore, the features defined by “first” and “second” can explicitly or implicitly include one or more features. In the description of the present application, “multiple” means two or more, unless otherwise specifically defined.

In the description of the present disclosure, it should be noted that, unless otherwise clearly specified, meanings of terms “mount”, “connect with”, and “connect to” should be understood in a broad sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand the specific meanings of the above terms in the present disclosure based on specific situations.

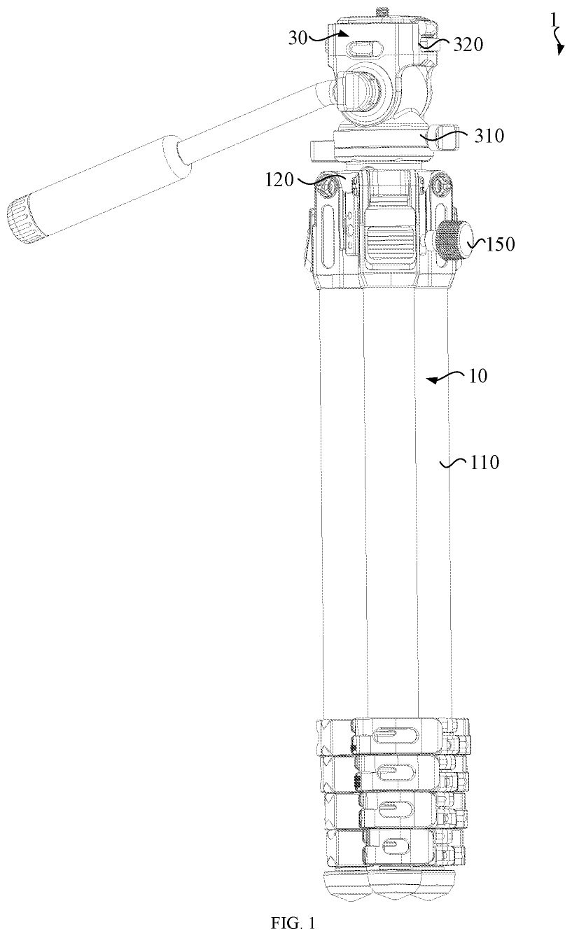

Referring to FIG. 1, the present disclosure provides support device 1. The support device 1 is mainly applied in the field of photography. Specifically, the support device 1 can be unfolded to form a tripod structure for mounting a photographic device. The support device 1 plays a role of fixing and supporting the photographic device, thereby achieving the mounting and fixation of the photographic device. In addition, after the photographic device is mounted on the support device 1, the support device 1 plays a role of stabilizing the photographic device. That is, the support device reduces an adverse effect of a user operation, such as shaking or swinging, on the photographic device, thereby improving the shooting quality of the photographic device. The photographic device can but is not limited to a camera, a smartphone, a tablet, and a gimbal holder, etc.

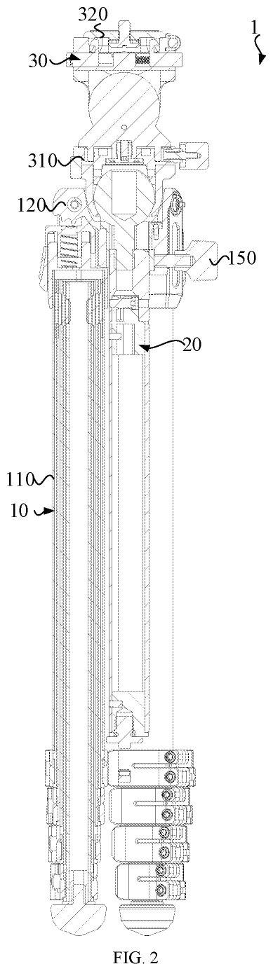

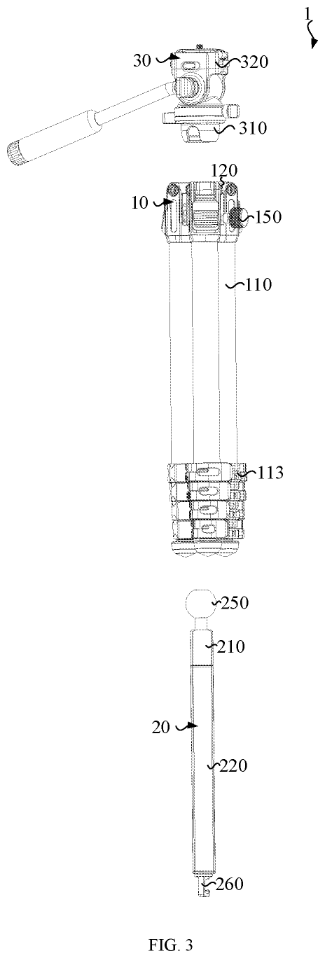

Referring to FIGS. 2 and 3, the support device 1 includes support leg assembly 10 and rod assembly 20. The rod assembly 20 serves as a central axis of the support leg assembly 10, and is movably connected to the support leg assembly 10.

Specifically, when the support device 1 is used, the support leg assembly 10 can be unfolded to form a tripod structure. After the support leg assembly 10 is unfolded, the photographic device is mounted on the rod assembly 20. The support leg assembly 10 plays a role of fixing and supporting the photographic device and the rod assembly 20, thereby achieving the mounting and fixation of the photographic device on the support device 1. Meanwhile, due to the movable connection between the rod assembly 20 and the support leg assembly 10, the rod assembly 20 is movable relative to the support leg assembly 10 so as to adjust the photographic device to a suitable shooting height. The design facilitates a user's shooting activities.

More specifically, when the support device 1 is not used, the photographic device is first detached from the rod assembly 20. After the photographic device is detached, the support leg assembly 10 is switched from an unfolded state to a folded state, and the support leg assembly 10 is attached to a periphery of the rod assembly 20.

The support device 1 further includes gimbal holder 30. The gimbal holder 30 is mounted on the rod assembly 20, and is configured to mount the photographic device. The photographic device is fixedly connected to the rod assembly 20 through the gimbal holder 30. The photographic device can also be detached from the gimbal holder 30. After the photographic device is detached from the gimbal holder, the gimbal holder 30 is detached from the rod assembly 20, thereby achieving the detachment of the gimbal holder 30.

It should be understood that in other embodiments, the gimbal holder 30 can be omitted, and in this case, the photographic device is directly mounted on the rod assembly 20.

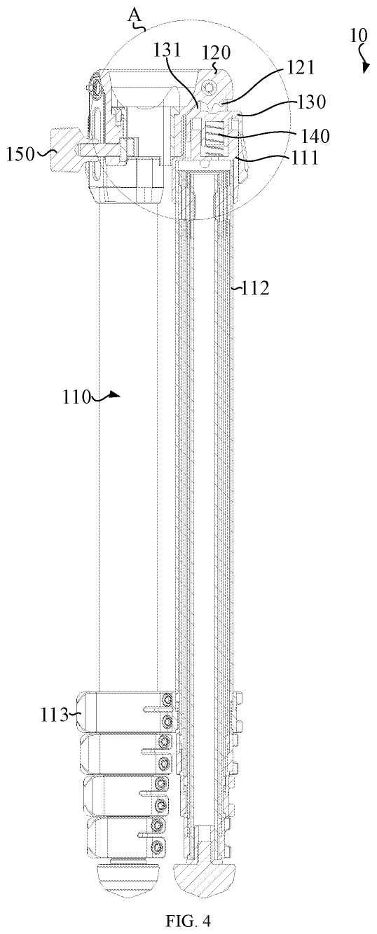

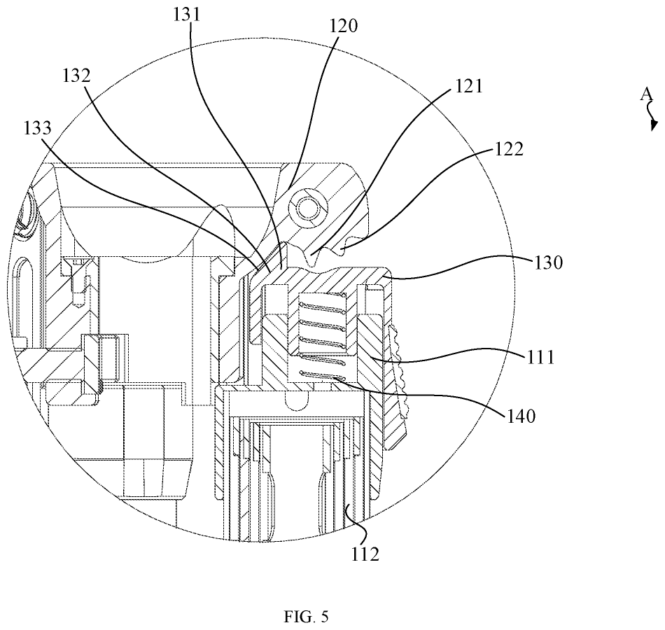

Referring to FIGS. 4 and 5, the support leg assembly 10 includes multiple support legs 110 and fixed seat 120. The multiple support legs 110 are rotatably connected to the fixed seat 120, and are spaced apart in a circumferential direction of the fixed seat 120.

Specifically, the multiple support legs 110 are rotatable relative to the fixed seat 120 to form the tripod structure, and the multiple support legs 110 play a role of fixing and supporting the rod assembly 20, the gimbal holder 30, and the photographic device.

More specifically, the multiple support legs 110 are further rotatable relative to the fixed seat 120 to switch from an unfolded state to a folded state, thereby achieving folding of the multiple support legs 110. After the multiple support legs are folded, the multiple support legs 110 are attached to the periphery of the rod assembly 20.

The support legs 110 each include rotating seat 111, multiple branch tubes 112 that are sequentially folded, and multiple locking members 113. The rotating seat 111 is rotatably connected to the fixed seat 120. The branch tube 112 at an outermost position is connected to the rotating seat 111. The multiple locking members 113 each are arranged between two adjacent ones of the branch tubes 112 to restrict movement of the two adjacent ones of the branch tubes 112 along a length extension direction of the branch tubes 112.

Specifically, the multiple branch tubes 112 are able to drive the rotating seat 111 to rotate relative to the fixed seat 120, so as to unfold the multiple support legs 110 into the tripod structure. The multiple locking members 113 are sequentially opened to release the restriction of the locking members 113 on the two adjacent ones of the branch tubes 112. Thus, the multiple branch tubes 112 can be sequentially unfolded along the length extension direction of the branch tubes 112 to increase a length of the support legs 110. After multiple branch tubes 112 are unfolded, the locking members 113 lock each two adjacent ones of the branch tubes 112 to prevent the unfolded multiple branch tubes 112 from being folded. Due to the extension of the length of the support legs 110, the photographic device mounted on the gimbal holder 30 is raised. Thus, the photographic device has a large shooting height, facilitating shooting.

If a large shooting height is not required, only the restriction implemented by one locking member 113 needs to be lifted. Therefore, when the support device 1 is used, the length of the support legs 110 is adjustable according to an actual need of the user, making it convenient for the user.

More specifically, the locking members 113 can also lift the restrictions on each two adjacent ones of the branch tubes 112. After the locking members 113 lift the restrictions, the multiple branch tubes 112 are switched from their original unfolded state to a folded state. Thus, the multiple branch tubes 112 can be folded sequentially. After the multiple branch tubes 112 are folded, the locking members 113 restrict the relative movement of each adjacent two branch tubes 112. Thus, the multiple branch tubes 112 can drive the rotating seat 111 to rotate relative to the fixed seat 120, and can be attached to an outer surface of the rod assembly 20, thereby achieving folding of the multiple support legs 110.

It can be understood that in other embodiments, if the length of the support legs 110 does not need to be adjusted to increase the shooting height of the photographic device, there may be only one branch tube 112 provided. Therefore, the present disclosure does not impose any limitation on the number of the branch tubes 112.

The support leg assembly 10 further includes multiple clamping members 130. The multiple clamping members 130 are respectively movably arranged on the support legs 110, and the clamping members 130 are further located between the support legs 110 and the fixed seat 120. When the support leg 110 is provided with the rotating seat 111, the clamping member 130 is movably provided on the rotating seat 111, and is located between the rotating seat 111 and the fixed seat 120. The clamping member 130 is movable along the length extension direction of the support leg 110 to be clamped to the fixed seat 120, thereby restricting the rotation of the support leg 110 relative to the fixed seat 120.

Specifically, when the multiple support legs 110 need to be unfolded, the support legs 110 are rotatable relative to the fixed seat 120 to be unfolded. After the support legs are unfolded to a preset angle, the clamping members 130 are movable along a side of the support leg 110 close to the fixed seat 120. Thus, the clamping members are clamped to the fixed seat 120, thereby restricting the rotation of the support legs 110 relative to the fixed seat 120.

More specifically, when the multiple support legs 110 need to be folded, the clamping members 130 are moved along a side of the support legs 110 away from the fixed seat 120 to be detached from the fixed seat 120. Thus, the restriction of the clamping members 130 on the rotation of the support legs 110 relative to the fixed seat 120 is lifted, and the support legs 110 are rotatable relative to the fixed seat 120, allowing the support legs to be folded.

In order to enable the clamping members 130 to be clamped to the fixed seat 120 so as to restrict the rotation of the support legs 110 relative to the fixed seat 120, the clamping members 130 each are provided with first locking structure 131, and the fixed seat 120 is provided with second locking structure 121. The clamping members 130 each are able to drive the first locking structure 131 to be clamped to the second locking structure 121, so as to restrict the rotation of the support legs 110 relative to the fixed seat 120. In addition, the clamping members 130 each can further drive the first locking structure 131 to be detached from the second locking structure 121, so as to lift the restriction on the rotation of the support legs 110 relative to the fixed seat 120.

Specifically, in this embodiment, the first locking structure 131 includes first clamping element 132, and the second locking structure 121 includes multiple second clamping elements 122 spaced apart at a periphery of the fixed seat 120. When the support legs 110 are unfolded to the preset angle, the clamping members 130 are able to drive the first clamping element 132 to be abutted against the second clamping element 122. The first clamping element 132 and the second clamping element 122 are abutted against each other to restrict the rotation of the support leg 110 relative to the fixed seat 120.

The second locking structure 121 is provided with the multiple second clamping elements 122. When the support leg 110 is rotated relative to the fixed seat 120, the first clamping element 132 is clamped between each two of the second clamping elements 122 one by one to gradually increase the unfolded angle of the support leg 110. The support leg 110 can be fixed at multiple different unfolded angles. When the user uses the support device 1, the unfolded angle of the support leg 110 can be determined according to the user's actual need. When it is necessary to unfold the support legs 110 to a maximum unfolded angle, the first clamping element 132 does not need to be clamped between each two of the second clamping elements 122 one by one. On the contrary, the first clamping element 132 is directly clamped between two second clamping elements 122 farthest from the rod assembly 20.

More specifically, when the multiple support legs 110 need to be folded, the clamping members 130 can drive the first clamping element 132 to move along a side of the support legs 110 away from the fixed seat 120, allowing the first clamping element to be detached from the two second clamping elements 122. Thus, the support legs 110 are rotatable relative to the fixed seat 120 so as to switch the support legs 110 from the unfolded state to the folded state.

There are multiple second clamping elements 122. When the support leg 110 is folded, the first clamping element 132 is detached from each two of the second clamping elements 122 one by one to gradually reduce the unfolded angle of the support leg 110. Alternatively, the clamping member 130 can drive the first clamping element 132 to directly detach from the multiple second clamping elements 122, allowing the support leg 110 to switch directly from the unfolded state to the folded state.

It can be understood that in other embodiments, the first locking structure 131 may include multiple second clamping elements 122, and the second locking structure 121 may include multiple first clamping elements 132. Alternatively, in other embodiments, the second locking structure 121 may include multiple clamping slots, and the first locking structure 131 may include a first clamping element 132. The first clamping elements 132 can be respectively clamped to the multiple clamping slots, such that the support leg 110 can be fixed at multiple different unfolded angles. Similarly, the first locking structure 131 may also include multiple clamping slots. Therefore, the present disclosure does not impose any limitation on the specific implementation of the first locking structure 131 and the second locking structure 121.

The first clamping element 132 is provided with slope 133. Specifically, when the multiple support legs 110 need to be folded, the support legs 110 can drive the first clamping element 131 to automatically detach from the two second clamping elements 122. Driven by the support legs 110, the second clamping element 122 close to the rod assembly 20 is moved along the slope 133, such that the first clamping member 132 is automatically detached from the two second clamping elements 122, thereby achieving the folding of multiple support legs 110. Due to the slope 133 of the first clamping element 132, when the multiple support legs 110 need to be folded, the first clamping element 132 can directly be detached from the two second clamping elements 122. There is no need to apply an external force to the clamping member 130 to drive the first clamping element 132 to be detached from the two second clamping elements 122, making it convenient for the user.

It can be understood that in other embodiments, the slope 133 can be omitted. In this case, an external force needs to be applied to the clamping member 130. Due to the external force, the clamping member 130 can drive the first clamping element 132 to be detached from the two second clamping elements 122. Therefore, the present disclosure does not impose any limitation on the specific implementation of the slope 133.

The support leg assembly 10 further includes elastic member 140. The elastic member 140 is provided between the clamping member 130 and the support leg 110. When the support leg 110 is provided with the rotating seat 111, the elastic member 140 is provided between the rotating seat 111 and the clamping member 130. The elastic member 140 is able to release an elastic force to make the clamping member 130 clamped to the fixed seat 120. Due to the action of the elastic force, the first clamping element 132 is clamped between the two second clamping elements 122.

Specifically, when the multiple support legs 110 need to be unfolded, the clamping members 130 can overcome the elastic force of the elastic member 140 to detach the first locking structure 131 from the second locking structure 121. In this case, an external force is applied to the support leg 110 so as to rotate the support leg 110 relative to the fixed seat 120, allowing the support leg to be unfolded. When the support leg 110 is unfolded to the preset angle, the clamping member 130 is released. The elastic member 140 releases the elastic force to clamp the first locking structure 131 to the second locking structure 121. Thus, the unfolded angle of the support leg 110 is fixed.

When the first locking structure 131 is provided with the first clamping element 132 and the second locking structure 121 is provided with the multiple second clamping elements 122, the clamping member 130 is movable along the length extension direction of the support leg 110 to detach the first clamping element 132 from the two second clamping elements 122. After the first clamping element 132 is detached from the two second clamping elements 122, the support legs 110 is rotated relative to the fixed seat 120 to increase the unfolded angle. After the unfolded angle of the support leg 110 is increased to the preset angle, the user releases clamping member 130. The elastic member 140 releases the elastic force to clamp the first clamping element 132 between the other two second clamping elements 122, thereby achieving multi-angle adjustment of the support leg 110.

More specifically, when the multiple support legs 110 need to be folded, the support legs 110 can be rotated relative to the fixed seat 120, so as to switch the support legs 110 from the unfolded state to the folded state. When the support leg 110 is rotated relative to the fixed seat 120, the support leg 110 drives the clamping member 130 to overcome the elastic force of the elastic member 140 to move along the side of the support leg 112 away from the fixed seat 120, so as to detach the first locking structure 131 from the second locking structure 121. The support leg 110 is rotatable relative to the fixed seat 120. That is, the support leg 110 is rotatable from the side away from the rod assembly 20 towards the side close to the rod assembly 20. In this way, the folding of the multiple support legs 110 is achieved. When the multiple support legs 110 are in a folded state, the elastic member 140 releases the elastic force, such that the first locking structure 131 is clamped to the second locking structure 121 to restrict the rotation of the support legs 110 relative to the fixed seat 120, thereby achieving the fixation of the multiple support legs 110.

It should be understood that when the first clamping element 132 is provided with the slope 133, the support leg 110 can drive the first clamping element 132 to automatically detach from the two second clamping elements 122. Thus, the support leg 110 is rotated relative to the fixed seat 120, allowing the support leg to be fold.

The support leg assembly 10 further includes adjustment knob 150. The adjustment knob 150 is connected to the fixed seat 120 in a threaded manner. The adjustment knob 150 is rotatable relative to the fixed seat 120, allowing the adjustment knob to be abutted against or detached from the rod assembly 20.

Specifically, the adjustment knob 150 is rotatable relative to the fixed seat 120 towards the side away from the rod assembly 20, allowing the adjustment knob 150 to be detached from the rod assembly 20. When the adjustment knob 150 is detached from the rod assembly 20, the rod assembly 20 is movable relative to the fixed seat 120 so as to increase or decrease the shooting height of the photographic device. After the shooting height is adjusted, the adjustment knob 150 is rotated relative to the fixed seat 120 towards the side close to the rod assembly 20. In this way, the adjustment knob 150 is abutted against the rod assembly 20 to restrict the movement of the rod assembly 20 relative to the fixed seat 120.

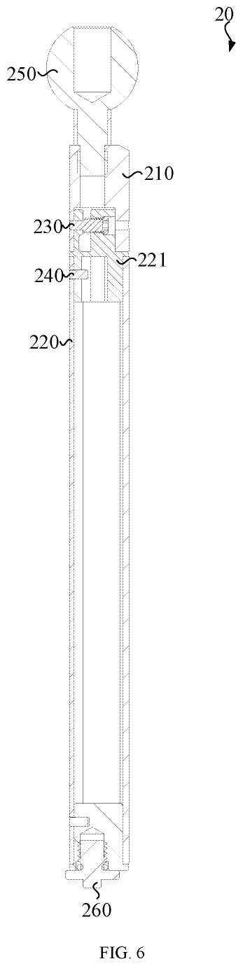

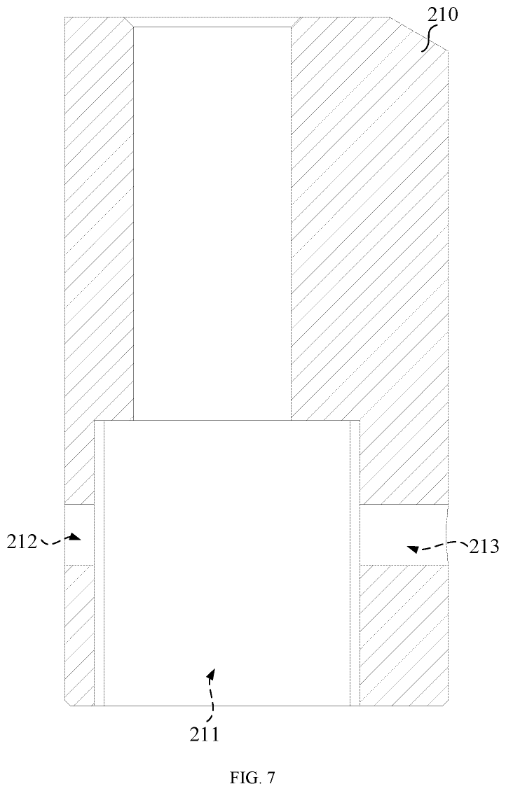

Referring to FIGS. 6 and 7, the rod assembly 20 includes first rod member 210, second rod member 220, and threaded connector 230. The second rod member 220 is provided with mounting seat 221. The mounting seat 221 is detachably mounted on the first rod member 210. The threaded connector 230 is connected to the mounting seat 221 in a threaded manner. The threaded connector 230 is rotatable relative to the mounting seat 221, allowing the threaded connector 230 to be clamped to the first rod member 210 and the mounting seat 221 and to push the mounting seat 221, such that an outer surface of the mounting seat 221 is abutted against an inner wall of the first rod member 210. When the support leg assembly 10 is provided with the fixed seat 120, the first rod member 210 or the second rod member 220 is movably connected to the fixed seat 120, such that the rod assembly 20 is movably connected to the fixed seat 120. An end of the first rod member 210 away from the second rod member 220 is configured to mount the photographic device. In this embodiment, the end of the first rod member 210 is configured to mount the gimbal holder 30.

Specifically, in this embodiment, the first rod member 210 is connected to the fixed seat 120. After the first rod member 210 is connected, the mounting seat 221 is mounted inside the first rod member 210. The adjustment knob 150 is abutted against the first rod member 210 to restrict the first rod member 210 from being detached from the fixed seat 120. The mounting seat 221 is mounted on the first rod member 210, and the threaded connector 230 is driven to rotate relative to the mounting seat 221, such that the threaded connector 230 is clamped to the first rod member 210 and the mounting seat 221 so as to restrict the mounting seat 221 from being detached from the first rod member 210. In this way, the first rod member 210 is fixedly connected to the second rod member 220. When the threaded connector 230 is rotated relative to the mounting seat 221, the threaded connector 230 can push the mounting seat 221, such that the outer surface of the mounting seat 221 is abutted against the inner wall of the first rod member 210 to increase a friction force between the mounting seat 221 and the first rod member 210. The design improves the stability of the connection between the mounting seat 221 and the first rod member 210.

After the first rod member 210 and the second rod member 220 are fixedly connected, the adjustment knob 150 is driven to rotate relative to the fixed seat 120, allowing the adjustment knob to be detached from the first rod member 210. After the adjustment knob 150 is detached from the first rod member 210, the first rod member 210 can drive the second rod member 220 and the gimbal holder 30 mounted on the first rod member 210 to move relative to the fixed seat 120. In this way, the rod assembly 20 is moved relative to the fixed seat 120. After the first rod member 210 is moved relative to the fixed seat 120, the user applies an external force to the adjustment knob 150. Due to the action of the external force, the adjustment knob 150 is rotated relative to the fixed seat 120, allowing the adjustment knob to be abutted against the rod assembly 20, such that the rod assembly 220 is relatively fixed to the fixed seat 120.

More specifically, when the second rod member 220 needs to be detached from the first rod member 210, the threaded connector 230 can be driven to rotate in reverse relative to the mounting seat 221, allowing the threaded connector to be detached from the first rod member 210. Thus, the second rod member 220 can drive the mounting seat 221 to be detached from the first rod member 210, such that the second rod member 220 is detached from the first rod member 210.

The first rod member 210 is in the shape of a triangular prism. Due to the triangular-prism shape of the first rod member 210, when the first rod member 210 is moved relative to the fixed seat 120, the first rod member 210 is not deflected relative to the fixed seat 120. In this way, the movement of the first rod member 210 relative to the fixed seat 120 is more stable. It can be understood that in other embodiments, the shape of the first rod member 210 can also be a cube or a rectangle, etc. Alternatively, when it is not necessary to restrict the deflection of the first rod member 210 relative to the fixed seat 120, the shape of the first rod member 210 can also be a cylinder. Therefore, the present disclosure does not impose any limitation on the shape of the first rod member 210.

The first rod member 210 is provided with mounting groove 211. Specifically, when the first rod member 210 and the second rod member 220 are fixedly connected, the mounting seat 221 can be accommodated in the mounting groove 211. The threaded connector 230 is rotatable relative to the mounting seat 221, allowing the threaded connector to be clamped to the first rod member 210 and the mounting seat 221, thereby restricting the fixed connection between the mounting seat 221 and the first rod member 210.

More specifically, the threaded connector 230 is further rotatable in reverse relative to the mounting seat 221, allowing the threaded connector to be detached from the first rod member 210. When the threaded connector 230 is detached from the first rod member 210, the second rod member 220 drives the mounting seat 221 to be detached from the mounting groove 211, causing the first rod member 210 to be detached from the second rod member 220.

The first rod member 210 is provided with through hole 212. Specifically, when the threaded connector 230 is clamped to the mounting seat 221 and the first rod member 210, the threaded connector 230 is passed through the through hole 212. Thus, the threaded connector 230 is clamped to the first rod member 210. More specifically, the threaded connector 230 is further rotatable in reverse relative to the mounting seat 221, allowing the threaded connector to be detached from the through hole 212. Thus, the threaded connector 230 lifts the restriction on the relative movement of the mounting seat 221 and the first rod member 210. In this way, the mounting seat 221 is detached from the mounting groove 211, causing the first rod member 210 to be detached from the second rod member 220.

The first rod member 210 is provided with operating hole 213. Specifically, an operating tool can be passed through the operating hole 213 to rotate an operating head of the threaded connector 230. In this way, the threaded connector 230 can be driven to rotate relative to the mounting seat 221, allowing the threaded connector to be clamped to the first rod member 210 and the mounting seat 221, such that the mounting seat 221 is fixedly connected to the first rod member 210. The operating tool can also be passed through the operating hole 213 to rotate the operating head of the threaded connector 230. In this way, the threaded connector 230 can be driven to rotate in reverse relative to the mounting seat 221, allowing the threaded connector to be detached from the first rod member 210, causing the threaded connector 230 to be detached from the through hole 212. Thus, the second rod member 220 can drive the mounting seat 221 to be detached from the mounting groove 211, causing the first rod member 210 to be detached from the second rod member 220. A diameter of the operating hole 213 is less than a diameter of the operating head of the threaded connector 230 so as to restrict the threaded connector 230 from being detached from the mounting seat 221 through the operating hole 213. It should be understood that the operating tool can but is not limited to a screwdriver or an electric screwdrivers, etc.

The second rod member 220 is in the shape of a triangular prism. Due to the triangular-prism shape of the second rod member 220, when the second rod member 220 is moved relative to the fixed seat 120, the second rod member 220 is not deflected relative to the fixed seat 120 In this way, the movement of the second rod member 220 relative to the fixed seat 120 is more stable. It can be understood that in other embodiments, the shape of the second rod member 220 can also be a cube or a rectangle, etc. Alternatively, when it is not necessary to restrict the deflection of the second rod member 220 relative to the fixed seat 120, the shape of the second rod member 220 can also be a cylinder. Therefore, the present disclosure does not impose any limitation on the shape of the second rod member 220.

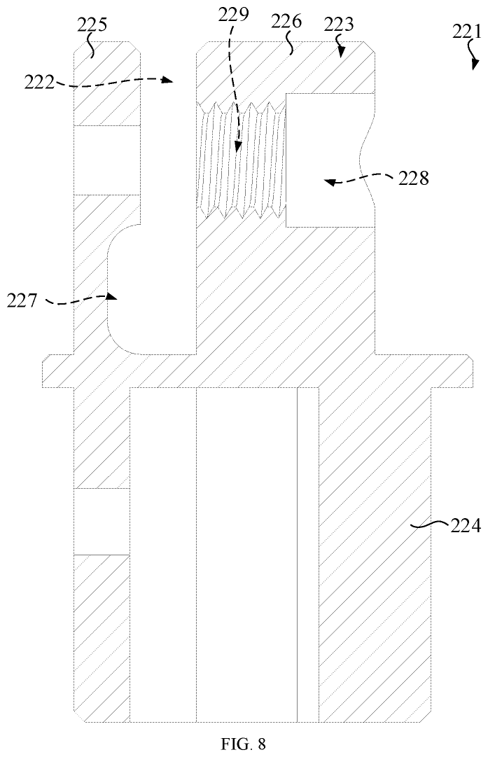

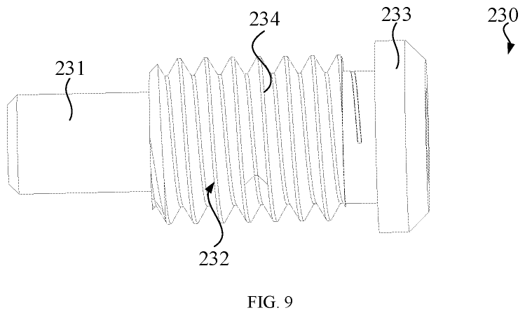

Referring to FIGS. 8 and 9, the mounting seat 221 is provided with expansion space 222 with an adjustable size. Specifically, when the threaded connector 230 is rotated relative to the mounting seat 221, the threaded connector 230 can expand the expansion space 222 so as to push the mounting seat 221. In this way, the outer surface of the mounting seat 221 is abutted against a wall of the mounting groove 211, thereby increasing the friction force between the mounting seat 221 and the first rod member 210.

The mounting seat 221 includes first connecting part 223 and second connecting part 224. The first connecting part 223 is detachably connected to the mounting groove 211, and the second connecting part 224 is connected to the second rod member 220. The expansion space 222 is provided on the first connecting part 223, and the threaded connector 230 is connected to the first connecting part 223 in a threaded manner.

Specifically, the first connecting part 223 can be mounted in the mounting groove 211. After the first connecting part 223 is mounted, the threaded connector 230 is rotatable relative to the first connecting part 223, allowing the threaded connector to be clamped to the first connecting part 223 and the first rod member 210. In this way, the first connecting part 223 is fixedly connected to the first rod member 210. When the threaded connector 230 is rotated relative to the first connecting part 223, the threaded connector 230 expands the expansion space 222 so as to push the first connecting part 223. In this way, the outer surface of the first connecting part 223 is abutted against the wall of the mounting groove 211 to increase the friction force between the first connecting part 223 and the first rod member 210.

More specifically, when it is necessary to detach the first connecting part 223 from the mounting groove 211, the threaded connector 230 can be rotated in reverse relative to the first connecting part 223 so as to be detached from the first rod member 210, causing the threaded connector 230 to be detached from the through hole 212. Thus, the expansion space 222 is narrowed, thereby restricting or reducing the abutment of the first connecting part 223 against the wall of the mounting groove 211. After the threaded connector 230 is detached from the through hole 212, the second rod member 220 can drive the first connecting part 223 to be detached from the mounting groove 211, causing the second connecting part 220 to be detached from the first rod member 210.

The first connecting part 223 includes first clamping element 225 and second clamping element 226. The first clamping element 225 and the second clamping element 226 define the expansion space 222, and are connected to the second connecting part 224. The threaded connector 230 is connected to one of the first clamping element 225 and the second clamping element 226 in a threaded manner. That is, the threaded connector 230 is connected to the first clamping element 225 in a threaded manner, or the threaded connector 230 is connected to the second clamping element 226 in a threaded manner. It should be noted that in this embodiment, the threaded connector 230 is connected to the second clamping element 226 in a threaded manner.

Specifically, when the first connecting part 223 needs to be fixedly connected to the first rod member 210, the second rod member 220 drives the first clamping element 225 and the second clamping element 226 to be accommodated in the mounting groove 211 through the second connecting part 224. The threaded connector 230 is rotatable relative to the second clamping element 226, allowing the threaded connector to be clamped to the first clamping element 225 and the first rod member 210. In this way, the threaded connector 230 restricts the first clamping element 225 from being detached from the mounting groove 211, ensuring the fixed connection of the first connecting part 223 and the first rod member 210. When the threaded connector 230 is rotated relative to the second clamping element 226, the threaded connector 230 is abutted against the first clamping element 225 to deform the first clamping element 225 towards the side away from the second clamping element 226, thereby expanding the expansion space 222. After the expansion space 222 is expanded, outer surfaces of the first clamping element 225 and the second clamping element 226 are abutted against the wall of the mounting groove 211, thereby increasing the friction force between the first connecting part 223 and the first rod member 210.

More specifically, when the first connecting part 223 needs to be detached from the first rod member 210, the threaded connector 230 can be rotated in reverse relative to the second clamping element 226 so as to be detached from the first rod member 210. Thus, the abutment of the first clamping element 225 and the second clamping element 226 against the wall of the mounting groove 211 is relieved or reduced. When the threaded connector 230 is detached from the first rod member 210, the second rod member 220 can drive the first clamping element 225 and the second clamping element 226 to be detached from the mounting groove 211 through the second connecting part 224, causing the first connecting part 223 to be detached from the first rod member 210.

In order to better expand the expansion space 222 between the first clamping element 225 and the second clamping element 226, at least one of the first clamping element 225 and the second clamping element 226 is provided with notch 227. The notch 227 is communicated with the expansion space 222. It should be understood that, in terms of the specific implementation of the notch 227, the first clamping element 225 is provided with the notch 227, and the second clamping element 226 is not provided with the notch 227. Alternatively, the first clamping element 225 is not provided with the notch 227, and the second clamping element 226 is provided with the notch 227. Alternatively, both the first clamping element 225 and the second clamping element 226 are provided with the notch 227.

Specifically, in this embodiment, the first clamping element 225 is provided with the notch 227, and the second clamping element 226 is not provided with the notch 227. Due to the notch 227 of the first clamping element 225, when the threaded connector 230 is abutted against the first clamping element 225, the threaded connector 230 can better drive the first clamping element 225 to deform towards the side away from the second clamping element 226, increasing the expansion space 222.

The second clamping element 226 is provided with countersunk hole 228 and threaded hole 229. The countersunk hole 228 and the expansion space 222 are located at two different sides of the threaded hole 229, and are communicated with the threaded hole 229. The threaded connector 230 is matched with the threaded hole 229, and the operating head of the threaded connector 230 is accommodated in the countersunk hole 228.

Specifically, when the support device 1 is used, the user can operate the operating tool to drive the operating head of the threaded connector 230 to rotate around a length extension direction of the countersunk hole 228. When the operating head is rotated, it drives the threaded connector 230 to rotate relative to the threaded hole 229. In this way, the threaded connector 230 is clamped to the first clamping element 225 and the first rod member 210, such that the first connecting part 223 is fixedly connected to the first rod member 210.

More specifically, the user can also use the operating tool to drive the threaded connector 230 to rotate in reverse around the length extension direction of the countersunk hole 228. When the operating head is rotated in reverse, it drives the threaded connector 230 to rotate in reverse relative to the threaded hole 229, allowing the threaded connector 230 to be detached from the first rod member 210. After the threaded connector 230 is detached from the first rod member 210, the second rod member 220 can drive the first clamping element 225 and the second clamping element 226 to be detached from the mounting groove 211 through the second connecting part 224, causing the first connecting part 223 to be detached from the first rod member 210.

Since the second clamping element 226 is provided with the countersunk hole 228, when the threaded connector 230 is detached from the first rod member 210, the countersunk hole 228 provides a space for movement. In this way, the threaded connector 230 is movable relative to the second clamping element 226 in an axial direction of the threaded connector 230.

The threaded connector 230 includes clamping end 231 and mounting end 232. The clamping end 231 is connected to the mounting end 232. The mounting end 232 is provided with a thread, and is connected to the second clamping element 226 in a threaded manner. When the second clamping element 226 is provided with the countersunk hole 228 and the threaded hole 229, the mounting end 232 is matched with the threaded hole 229, and the mounting end 232 is partially accommodated in the countersunk hole 228.

Specifically, when the first clamping element 225 and the second clamping element 226 are accommodated in the mounting groove 211, the user can operate the operating tool so as to drive the mounting end 232 to rotate relative to the threaded hole 229. Thus, the clamping end 231 is driven to move towards the side close to the first clamping element 225, such that the clamping end 231 is clamped to the first clamping element 225 and the first rod member 210, thereby achieving the fixed connection of the first connecting part 223 and the first rod member 210. When the mounting end 232 is rotated relative to the threaded hole 229, the mounting end 232 is abutted against the outer surface of the first clamping element 225. Pushed by the mounting end 232, the first clamping element 225 is deformed towards the side away from the second clamping element 226, thereby increasing the expansion space 222.

More specifically, when the user needs to detach the first connecting part 223 from the first rod member 210, the user can operate the operating tool so as to drive the mounting end 232 to rotate in reverse relative to the threaded hole 229. Thus, the clamping end 231 is driven to move towards the side away from the first clamping element 225, causing the clamping end 231 to be detached from the first rod member 210. After the clamping end 231 is detached from the first rod member 210, the first clamping element 225 and the second clamping element 226 are detached from the mounting groove 211, causing the first connecting part 223 to be detached from the first rod member 210. When the mounting end 232 is rotated in reverse relative to the threaded hole 229, the push of the mounting end 232 gradually decreases, and the first clamping element 225 is reset. Due to the reset of the first clamping element 225, the expansion space 222 is restored. The abutment of the first clamping element 225 and the second clamping element 226 against the wall of the mounting groove 211 is relieved or reduced.

The mounting end 232 includes cap 233 and screw rod 234. The cap 233 is accommodated in the countersunk hole 228 to form the operating head of the threaded connector 230. The screw rod 234 is provided with a thread. The screw rod 234 includes two opposite ends connected to the cap 233 and the clamping end 231 respectively, and is matched with the threaded hole 229.

Specifically, when the first clamping element 225 and the second clamping element 226 are accommodated in the mounting groove 211, the user can operate the operating tool so as to drive the cap 233 to rotate around the length extension direction of the countersunk hole 228. When the cap 233 is rotated, it drives the screw rod 234 to rotate relative to the threaded hole 229. When the screw rod 234 is rotated, it drives the clamping end 231 to move towards the side close to the first clamping element 225, so as to drive the clamping end 231 to be clamped to the first clamping element 225 and the first rod member 210. Thus, the first clamping element 225 is fixedly connected to the first rod member 210. When the screw rod 234 is rotated relative to the threaded hole 229, the screw rod 234 is abutted against the outer surface of the first clamping element 225 so as to drive the first clamping element 225 to deform towards the side away from the second clamping element 226, thereby increasing the expansion space 222.

More specifically, when the first clamping element 225 and the second clamping element 226 need to be detached from the mounting groove 211, the user can operate the operating tool so as to drive the cap 233 to rotate in reverse around the length extension direction of the countersunk hole 228. The countersunk hole 228 provides a moving space for the cap 233. Thus, when the cap 233 is rotated in reverse, the cap 233 is not abutted against the wall of the mounting groove 211. The design avoids the problem of difficult rotation of the cap 233. When the cap 233 is rotated in reverse, it drives the screw rod 234 to rotate in reverse relative to the threaded hole 229. When the screw rod 234 is rotated in reverse, it drives the clamping end 231 to move towards the side away from the first clamping element 225 so as to be detached from the first rod member 210. After the clamping end 231 is detached from the first rod member 210, the second rod member 220 can drive the first clamping element 225 and the second clamping element 226 to be detached from the mounting groove 211, causing the first connecting part 223 to be detached from the first rod member 210.

When the screw rod 234 is rotated in reverse relative to the threaded hole 229, the push of the screw rod 234 on the first clamping element 225 is reduced or eliminated to reset the first clamping element 225. Due to the reset of the first clamping element 225, the expansion space 222 is restored.

In summary, in the support device 1 provided by the present disclosure, the rod assembly 20 is provided with the threaded connector 230. Specifically, when the support device 1 is used, the threaded connector 230 can be clamped to the first rod member 210 and the mounting seat 221 to restrict the first rod member 210 from being detached from the mounting seat 221. When the threaded connector 230 is clamped to the first rod member 210 and the mounting seat 221, the threaded connector 230 can further push the mounting seat 221 to make the outer surface of the mounting seat 221 abutted against the wall of the mounting groove 211. In this way, the friction force between the mounting seat 221 and the first rod member 210 is increased. When the second rod member 220 is disturbed by an external force, such as when the second rod member is accidentally touched, the second rod member 220 cannot drive the mounting seat 221 to overcome the resistance between the first rod member 210 and the mounting seat 221 exerted by the threaded connector 230, as well as the friction force between the mounting seat 221 and the first rod member 210, so as to rotate relative to the first rod member 210. Therefore, the mounting seat cannot be detached from the first rod member 210, so the connection between the first rod member 210 and the second rod member 220 is more secure. In this way, the present disclosure solves the problem of weak connection between the first rod member and the second rod member in a traditional rod assembly. That is, the first rod member and the second rod member are connected in a threaded manner, and when the second rod member is disturbed by an external force, such as when the second rod member is accidentally touched, the second rod member is rotated relative to the first rod member to be detached from the first rod member.

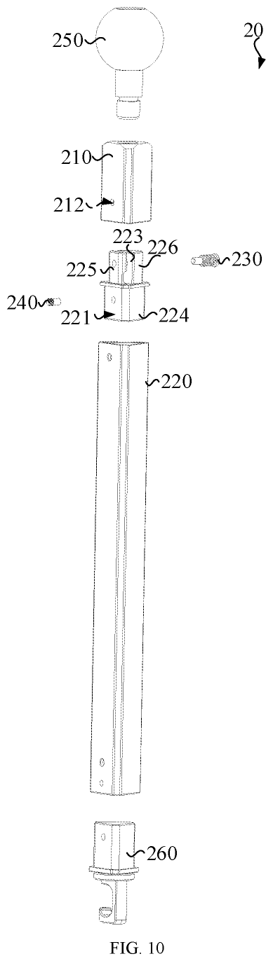

Referring to FIG. 10, in an embodiment, the mounting seat 221 is detachably connected to the second rod member 220. When the mounting seat 221 is provided with the second connecting part 224, the second connecting part 224 is detachably connected to the second rod member 220. Specifically, the mounting seat 221 is accommodated in the second rod member 220 to achieve the connection of the mounting seat 221 to the second rod member 220. The mounting seat 221 can further be detached from the second rod member 220 to achieve the detachment of the mounting seat 221 from the second rod member 220.

It can be understood that in other embodiments, the mounting seat 221 may also be fixedly connected to the second rod member 220. In this case, the mounting seat 221 is integrated with the second rod member 220.

In an embodiment, the rod assembly 20 further includes locking pin 240. The locking pin 240 can be clamped to the mounting seat 221 and the second rod member 220 to restrict the second rod member 220 from being detached from the mounting seat 221, such that the second rod member 220 is fixedly connected to the mounting seat 221.

The locking pin 240 can be detached from the mounting seat 221 and the second rod member 220, causing the second rod member 220 to be detached from the mounting seat 221, thereby achieving the detachment of the second rod member 220 from the mounting seat 221.

It should be understood that in other embodiments, when the second rod member 220 is fixedly connected to the mounting seat 221, the locking pin 240 can be omitted.

In an embodiment, the rod assembly 20 further includes connector 250 and hook 260. The connector 250 is connected to the first rod member 210, and one end of the connector 250 away from the first rod member 210 is a spherical end for mounting the photographic device. The hook 260 is provided at one end of the second rod member 220 away from the first rod member 210.

Specifically, the gimbal holder 30 can be mounted on the connector 250. In this case, the photographic device can be mounted on the gimbal holder 30, allowing the photographic device to be fixedly connected to the support device 1. Due to the spherical end of the connector 250, the gimbal holder 30 is rotatable at multiple angles relative to the connector 250. In this way, the photographic device mounted on the connector 250 can shoot from multiple angles, thus meeting the user's needs for multi-angle photography.

More specifically, some item carried by the user can be fixed to the support device 1 through the hook 260. For example, a camera bag can be fixed to the support device 1 through a hook 260, facilitating the storage of the item carried by the user. When the support device 1 is used in a strong wind environment, a heavy object can be hung on the hook 260 to improve the overall stability of the support device 1.

It should be understood that in addition to the above mounting method of the connector 250 and the hook 260, the connector 250 and the hook 260 can also be mounted in other ways. For example, the connector 250 is mounted at one end of the second rod member 220 away from the first rod member 210, and the hook 260 is mounted at the end of the first rod member 210. After the connector 250 is mounted on the second rod member 220, the user can mount the photographic device on the connector 250. In this way, the photographic device has a low shooting height, which meets the user's need for low-height photography.

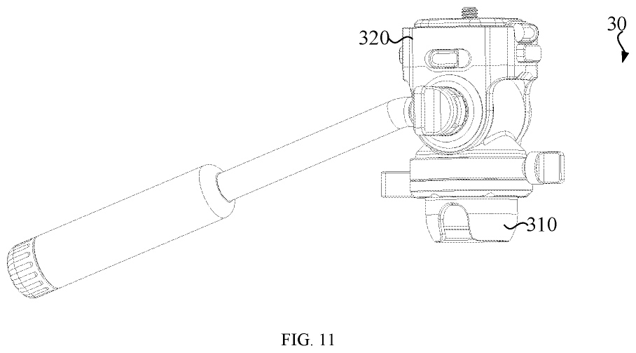

Referring to FIG. 11, in an embodiment, the gimbal holder 30 includes rotating part 310 and mounting part 320. The rotating part 310 is rotatably connected to the connector 250, the mounting part 320 is rotatably connected to the rotating part 310, and the mounting part 320 is provided with a thread for mounting the photographic device.

Specifically, the photographic device can be mounted on the mounting part 320 to achieve the fixed connection between the photographic device and the gimbal holder 30. After the photographic device is mounted and fixed, the rotating part 310 is rotatable relative to the connector 250 so as to drive the photographic device mounted on the mounting part 320 to deflect, allowing the photographic device to shoot at different angles. Due to the spherical end of the connector 250, when the rotating part 310 is rotated relative to the connector 250, the rotating part 310 is rotatable relative to the connector 250 within a 360-degree range. The mounting part 320 can further be rotatable relative to the rotating part 310. In other words, the mounting part 320 can drive the photographic device to pitch relative to the rotating part 310, thereby increasing the shooting angles of the photographic device.

The present disclosure is described above with reference to several typical implementations. It should be understood that the terms used herein are intended for illustration, rather than limiting. The present disclosure may be specifically implemented in many forms without departing from the spirit or essence of the present disclosure. Therefore, it should be understood that the above embodiments are not limited to any of the above-mentioned details, but should be broadly interpreted according to the spirit and scope defined by the appended claims. Therefore, any changes and modifications falling within the claims or the equivalent scope thereof should be covered by the appended claims.

What is claimed is:

1. A rod assembly, comprising:
a first rod member, provided with a mounting groove;
a second rod member, provided with a mounting seat detachably connected to the mounting groove; and
a threaded connector, connected to the mounting seat in a threaded manner, and rotatable relative to the mounting seat, allowing the threaded connector to be clamped to the first rod member and the mounting seat, and to push the mounting seat causing an outer surface of the mounting seat to be abutted against a wall of the mounting groove.

2. The rod assembly according to claim 1, wherein the mounting seat is provided with an expansion space having an adjustable size; and when the threaded connector is rotated relative to the mounting seat, the threaded connector expands the expansion space to push the mounting seat.

3. The rod assembly according to claim 2, wherein the mounting seat comprises a first connecting part and a second connecting part; the first connecting part is detachably connected to the mounting groove; the threaded connector is connected to the first connecting part in a threaded manner; and the second connecting part is connected to the second rod member; and
the first connecting part comprises a first clamping element and a second clamping element; the first clamping element and the second clamping element are connected to the second connecting part, and define the expansion space; the threaded connector is connected to one of the first clamping element and the second clamping element in a threaded manner; and the threaded connector is rotatable relative to the first connecting part, allowing the threaded connector to be clamped to the first clamping element and the first rod member, and to be abutted against the first clamping element causing the first clamping element to be deformed towards a side away from the second clamping element to expand the expansion space.

4. The rod assembly according to claim 3, wherein at least one of the first clamping element and the second clamping element is provided with a notch; and the notch is communicated with the expansion space.

5. The rod assembly according to claim 3, wherein the threaded connector comprises a clamping end and a mounting end; the clamping end is connected to the mounting end; the mounting end is provided with a thread, and is connected to the second clamping element in a threaded manner; the mounting end is rotatable relative to the second clamping element causing the clamping end to be clamped to the first rod member and the first clamping element; and when the mounting end is rotated relative to the second clamping element, the mounting end is abutted against an outer surface of the first clamping element to expand the expansion space.

6. The rod assembly according to claim 5, wherein the second clamping element is provided with a countersunk hole and a threaded hole; the countersunk hole and the expansion space are located at two different sides of the threaded hole, and are communicated with the threaded hole; the mounting end comprises a cap and a screw rod; the cap is accommodated in the countersunk hole; the screw rod comprises two opposite ends connected to the cap and the clamping end, respectively; the screw rod is provided with the thread, and is matched with the threaded hole; and the cap is rotatable around a length extension direction of the countersunk hole to drive the screw rod to rotate relative to the threaded hole, allowing the clamping end to be clamped to the first rod member and the first clamping element.

7. The rod assembly according to claim 1, wherein the first rod member is provided with an operating hole; when the mounting seat is provided in the mounting groove, the operating hole is aligned with an operating head of the threaded connector; and the operating hole has a diameter less than a diameter of the operating head of the threaded connector.

8. The rod assembly according to claim 1, wherein the mounting seat is detachably connected to the second rod member; the rod assembly further comprises a locking pin; the locking pin is able to be clamped to the mounting seat and the second rod member to restrict the second rod member from being detached from the mounting seat; and the locking pin is further able to be detached from the mounting seat and the second rod member, allowing the second rod member to be detached from the mounting seat.

9. The rod assembly according to claim 1, further comprising a connector and a hook, wherein the connector is connected to the first rod member, and one end of the connector away from the first rod member is a spherical end for mounting a photographic device; and the hook is connected to the second rod member.

10. A support device, comprising:
a support leg assembly; and
a rod assembly, serving as a central axis of the support leg assembly, movably connected to the support leg assembly, and comprising a first rod member, a second rod member, and a threaded connector, wherein the first rod member is provided with a mounting groove; the second rod member is provided with a mounting seat detachably connected to the mounting groove; and the threaded connector is connected to the mounting seat in a threaded manner, and rotatable relative to the mounting seat, allowing the threaded connector to be clamped to the first rod member and the mounting seat, and to push the mounting seat causing an outer surface of the mounting seat to be abutted against a wall of the mounting groove.

11. A support device, comprising:
a support leg assembly, comprising a fixed seat, multiple support legs, and multiple clamping members, wherein the multiple support legs are rotatably connected to the fixed seat, are spaced apart in a circumferential direction of the fixed seat, and are rotatable relative to the fixed seat to switch the support leg assembly between an unfolded state and a folded state; the clamping members are provided between the fixed seat and the support legs; in the unfolded state, the clamping members are able to be clamped to the fixed seat to restrict rotation of the support legs relative to the fixed seat and to prevent the support legs from being unfolded continuously; and the support legs are further configured to drive the clamping members to be detached from the fixed seat, allowing the support legs to rotate relative to the fixed seat to switch the support leg assembly from the unfolded state to the folded state; and
a rod assembly, serving as a central axis of the support leg assembly, movably connected to the support leg assembly, and comprising a first rod member and a second rod member, wherein the first rod member is provided with a mounting groove; and the second rod member is provided with a mounting seat detachably connected to the mounting groove.

12. The support device according to claim 11, wherein the clamping members each are provided with a first locking structure, and the fixed seat is provided with a second locking structure; the clamping member is able to drive the first locking structure to be clamped to the second locking structure to restrict the rotation of the support leg relative to the fixed seat; and the clamping member is further able to drive the first locking structure to be detached from the second locking structure to lift the restriction on the rotation of the support leg relative to the fixed seat.

13. The support device according to claim 12, wherein the first locking structure comprises a first clamping element; the second locking structure comprises multiple second clamping elements that are spaced apart at a periphery of the fixed seat; the clamping member is configured to drive the first clamping element to be clamped between two adjacent ones of the second clamping elements to restrict the rotation of the support leg relative to the fixed seat; and the clamping member is further able to drive the first clamping element to be detached from the two adjacent ones of the second clamping elements to lift the restriction on the rotation of the support leg relative to the fixed seat.

14. The support device according to claim 13, wherein the first clamping element is provided with a slope; and when the clamping member drives the first clamping element to be detached from the two adjacent ones of the second clamping elements, the second clamping element close to the rod assembly is moved along the slope, causing the first clamping element to be detached from the two adjacent ones of the second clamping elements.

15. The support device according to claim 11, wherein the support leg assembly further comprises an elastic member; the elastic member is provided between the clamping member and the support leg; the elastic member is configured to release an elastic force to make the clamping member clamped to the fixed seat; and the support leg is able to drive the clamping member to overcome the elastic force of the elastic member, allowing the support leg to rotate relative to the fixed seat.

16. The support device according to claim 11, wherein the support legs each comprise a rotating seat, multiple branch tubes that are sequentially folded, and multiple locking members; the rotating seat is rotatably connected to the fixed seat; the branch tube at an outermost position is connected to the rotating seat; and the multiple locking members each are arranged between two adjacent ones of the branch tubes to restrict movement of the two adjacent ones of the branch tubes along a length extension direction of the branch tubes.

17. The support device according to claim 11, wherein the support leg assembly further comprises an adjustment knob; the adjustment knob is connected to the fixed seat in a threaded manner; and the adjustment knob is rotatable relative to the fixed seat, allowing the adjustment knob to be abutted against or detached from the rod assembly.

18. The support device according to claim 11, wherein the clamping member is movable along a length extension direction of the support leg to lift a restriction of the clamping member on unfolding the support leg.

19. The support device according to claim 11, further comprising a gimbal holder, wherein the gimbal holder is provided on the rod assembly, and is configured to mount a photographic device.

20. The support device according to claim 19, wherein the gimbal holder comprises a rotating part and a mounting part; the rotating part is rotatably connected to the rod assembly, and is rotatable at multiple angles relative to the rod assembly; the mounting part is rotatably connected to the rotating part to achieve tilt rotation; and the mounting part is configured to mount the photographic device.
